(19) United States
(12) Patent Application Publication
(10) Pub. No.: US 2025/0377195 A1
(43) Pub. Date: Dec. 11, 2025

(54) INSPECTION DEVICE, IMAGE FORMING APPARATUS, INSPECTION METHOD, AND NON-TRANSITORY RECORDING MEDIUM

(71) Applicant: Satoshi SUZUKI, Kanagawa (JP)

(72) Inventor: Satoshi SUZUKI, Kanagawa (JP)

(21) Appl. No.: 19/223,065

(22) Filed: May 30, 2025

(30) Foreign Application Priority Data
Jun. 7, 2024 (JP) 2024-093297

(51) Int. Cl. G01B 11/16; G03G 15/00; G06T 7/00; G06T 7/50

(52) U.S. Cl. CPC G01B 11/16; G03G 15/6573; G06T 7/0004; G06T 7/50; G03G 2215/00717; G06T 2207/30144; G06T 2207/30204

(57) ABSTRACT

An inspection device includes a reader to read data of an inspection target; and circuitry that detects a vertex of the inspection target from the read data of the inspection target; calculates an angle indicating a shape of the inspection target at the detected vertex; and determines whether a deformation is present in the inspection target, and the circuitry determines that a deformation is present in the inspection target when the calculated angle is outside a predetermined range.

### CROSS-REFERENCE TO RELATED APPLICATIONS

This patent application is based on and claims priority pursuant to 35 U.S.C. § 119(a) to Japanese Patent Application No. 2024-093297, filed on Jun. 7, 2024, in the Japan Patent Office, the entire disclosure of which is hereby incorporated by reference herein.

### BACKGROUND

### Technical Field

The present disclosure relates to an inspection device, an image forming apparatus, an inspection method, and a non-transitory recording medium.

### Related Art

In the related art, a deformation such as a crease of a sheet conveyed in an image forming apparatus such as a printer may cause a streak on the sheet. This streak is a defect recognized by touch with a finger or the like as well as a defect recognized with eyes from the appearance.

A technique of the related art has an issue in that a streak caused in the process of image formation irrespective of the deformation of a sheet is falsely detected (false detection) as being a “deformation”. Lowering the detection level to avoid such false detection may also cause an issue in that a streak caused by a deformation is no longer detectable and thus whether a deformation is present is no longer accurately detectable.

### SUMMARY

The present disclosure described herein provides an inspection device including a reader and circuitry. The reader reads data of an inspection target. The circuitry detects a vertex of the inspection target from the read data of the inspection target, calculates an angle indicating a shape of the inspection target at the detected vertex, and determines whether a deformation is present in the inspection target. The circuitry determines that a deformation is present in the inspection target when the calculated angle is outside a predetermined range.

The present disclosure described herein provides an image forming apparatus including an image forming device, a fixing device, a reader, circuitry, and a memory. The image forming device forms an image on a medium that is conveyed. The fixing device fixes the formed image onto the medium. The reader reads data of an inspection target that is the medium on which the image has been fixed. The circuitry detects a vertex of the inspection target from the read data of the inspection target, calculates an angle indicating a shape of the inspection target at the detected vertex, and determines whether a deformation is present in the inspection target. The memory stores a number of times a deformation is determined to be present in the inspection target. The circuitry determines that a deformation is present in the inspection target when the calculated angle is outside a predetermined range.

The present disclosure described herein provides an inspection method to be executed by an inspection device, the inspection device including a reader to read data of an inspection target, the inspection method including detecting a vertex of the inspection target from the read data of the inspection target; calculating an angle indicating a shape of the inspection target at the vertex detected in the detecting; and determining whether a deformation is present in the inspection target. The determining includes determining a deformation is present in the inspection target when the angle calculated in the calculating is outside a predetermined range.

The present disclosure described herein provides a non-transitory recording medium storing a plurality of instructions which, when executed by one or more processors, causes the processors to perform the above-described inspection method.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an example of a schematic configuration of an image forming apparatus according to a first embodiment of the present disclosure;

FIG. 2 is a diagram illustrating an example of a hardware configuration of a printer;

FIG. 3 is a diagram illustrating an example of content of job information;

FIG. 4 is a diagram illustrating an example of a configuration of an inspection device;

FIG. 5 is a block diagram illustrating a functional configuration of an inspection process of the inspection device according to the first embodiment;

FIG. 6 is a diagram illustrating an example of vertices at four corners of an inspection target;

FIGS. 7A, 7B, 7C, and 7D are diagrams each illustrating an example of a template for detecting a vertex of the inspection target;

FIG. 8 is a diagram illustrating an example of a search range limited to an area near each vertex;

FIG. 9 is a diagram illustrating an example of vectors for use in calculation of an angle;

FIGS. 10A and 10B are diagrams illustrating an example of setting a predetermined range used by a determination unit;

FIGS. 11A, 11B, and 11C are diagrams each illustrating an example of a detection result notification displayed by a notification unit;

FIG. 12 is a flowchart illustrating an example of a procedure of the inspection process in the first embodiment;

FIG. 13 is a diagram illustrating an example of a three-dimensional (3D) object which is the inspection target;

FIGS. 14A and 14B are diagrams illustrating a comparative example of setting a print operation to be performed at detection of a defect;

FIG. 15 is a block diagram illustrating a functional configuration of an inspection process of an inspection device according to a second embodiment of the present disclosure;

FIG. 16 is a diagram illustrating another example of the detection result notification displayed by the notification unit;

FIG. 17 is a diagram illustrating an example of a setting screen for improving a print operation; and

FIG. 18 is a flowchart illustrating an example of a procedure of the inspection process according to the second embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

An inspection device, an image forming apparatus, an inspection method, and a program according to embodiments of the present disclosure will be described in detail below with reference to the accompanying drawings.

### First Embodiment

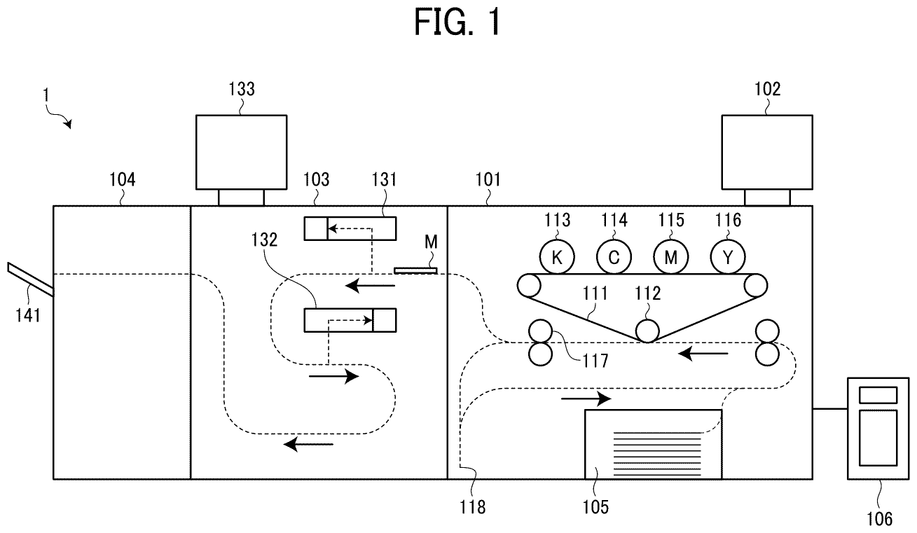

FIG. 1 is a diagram illustrating an example of a schematic configuration of an image forming apparatus according to a first embodiment of the present disclosure. An image forming apparatus 1 includes a printer 101, an operation device 102, an inspection device 103, and a stacker 104. The inspection device 103 may be included in the image forming apparatus 1 as illustrated in FIG. 1, may be used alone, or may be included in an apparatus other than the image forming apparatus 1.

The printer 101 receives a print job including a raster image processor (RIP) image, which is an image to be printed, from an external image generation controller 106, or receives an instruction to execute a print job stored in the printer 101. In accordance with the content of the print job, the printer 101 performs an image forming process on a conveyed medium. The medium is not limited to a sheet and may be any medium on which an image is formable. The image generation controller 106 is an external device of a digital frontend (DFE).

The printer 101 includes drums 113, 114, 115, and 116, a belt 111, a roller 112, a fixing device 117, and a reverse path 118, for example.

Specifically, the printer 101 controls each mechanism to obtain a sheet from a sheet feeder 105 at the bottom of the printer 101 and conveys the sheet along a path indicated by a broken line in FIG. 1.

The drums 113, 114, 115, and 116 respectively superimpose toner images of black (K), cyan (C), magenta (M), and yellow (Y) formed thereon by an optical writing device based on the image to be printed, onto the belt 111. The roller 112 transfers the composite toner image on the belt 111 onto the conveyed sheet. The drums 113, 114, 115, and 116, the belt 111, and the roller 112 are an example of an image forming device.

The fixing device 117 is a roller that fixes the toner image onto the sheet. In the case of single-sided printing, the sheet is ejected to the inspection device 103 after the toner image is fixed onto the sheet.

In the case of double-sided printing, the sheet is reversed in the reverse path 118. Another toner image is transferred and fixed onto the opposite side of the sheet. The sheet is then ejected to the inspection device 103.

The operation device 102 is, for example, an operation panel via which the printer 101 is operated.

The inspection device 103 is a device that inspects a printed medium M which is a sheet that has undergone printing and has been ejected. The printed medium M is an example of an inspection target.

An operation device 133 is, for example, an operation panel via which the inspection device 103 is operated. The operation device 133 is provided in the inspection device 103 in FIG. 1. Alternatively, the operation device 102 of the printer 101 may also serve as the operation device 133 of the inspection device 103. The operation device 102 of the printer 101 or the operation device 133 of the inspection device 103 may be implemented by an information processing apparatus, such as a personal computer (PC), connected to the image forming apparatus 1 via a local area network (LAN).

The operation device 102 and the operation device 133 each include a display unit and operation keys. The display unit serves as a display to display a current setting value, a selection screen, and the like, and as a touch panel to receive input from an operator. The operation keys include a numeral keypad to receive input of a numerical value such as the setting value. The display unit receives touch input from a user (i.e., operator). The user can perform operations such as inputting a numerical value into an input box displayed on a screen, selecting a pull-down menu, and checking or unchecking a checkbox using, for example, a finger or a pen. The operation keys may include an input device such as a trackball or a touch pad in addition to the numeral keypad.

The inspection device 103 reads, with readers 131 and 132, respective sides of the printed medium M ejected from the printer 101, and ejects the printed medium M. The readers 131 and 132 are each implemented by a line sensor or an image sensor. The readers 131 and 132 each read the printed medium M and output read image data.

The stacker 104 stacks the printed medium M ejected from the inspection device 103 on a tray 141.

### Description of Configuration of Printer Body

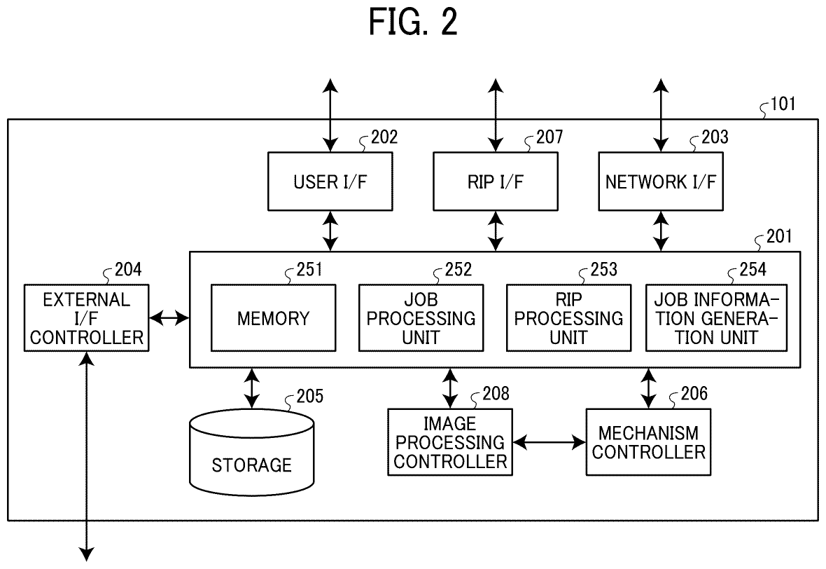

FIG. 2 is a diagram illustrating an example of a hardware configuration of the printer 101. The printer 101 includes a system controller 201, a user interface (I/F) 202, a network I/F 203, an external I/F controller 204, a storage 205, a mechanism controller 206, a raster image processor (RIP) I/F 207, and an image processing controller 208.

The system controller 201 is a controller that controls the entire printer 101. The user I/F 202 is an interface that connects the system controller 201 to the operation device 102. The network I/F 203 is an interface that connects the system controller 201 to a network such as a LAN. The external I/F controller 204 is an interface that connects the system controller 201 to another device.

The storage 205 is a storage device such as a hard disk drive. The mechanism controller 206 is a controller that controls operations such as sheet conveyance and a transfer process in the printer 101. The RIP I/F 207 is an interface that connects the system controller 201 to the image generation controller 106. The image processing controller 208 controls image processing.

The system controller 201 includes a memory 251, a job processing unit 252, a RIP processing unit 253, and a job information generation unit 254.

The job processing unit 252 processes a print job to generate job management information and print data. The RIP processing unit 253 converts the print data of the print job into RIP image data. The job information generation unit 254 generates job information indicating processing details of the print job.

### Description of Operation of Printer

An operation of the printer 101 will be described. Based on job information, the printer 101 performs a printing process on a page-by-page basis of an image to be printed.

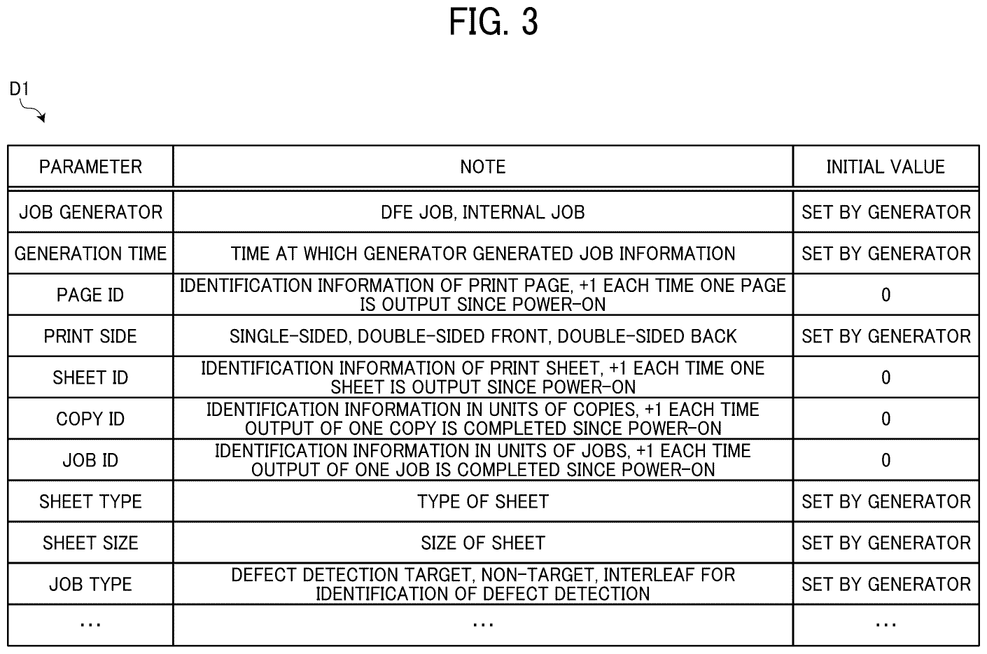

FIG. 3 is a diagram illustrating an example of content of the job information. As illustrated in FIG. 3, parameters such as a “job generator”, a “generation time”, a “page ID”, a “print side”, a “sheet ID”, a “copy ID”, a “job ID”, a “sheet type”, a “sheet size”, and a “job type” are set in job information D1. In the case of double-sided printing, job information is generated for each of the front and back sides of the sheet.

The “job generator” is information indicating an output source of a job. The “job generator” includes information indicating whether a job is a DFE job or an internal job. The DFE job indicates a job output by the image generation controller 106. The internal job indicates internal data of the printer 101. The “generation time” is information indicating the time at which the job generator generated the job information D1.

The “page ID” is an identification number of a print page. The “page ID” is incremented by 1 each time one page is processed since the power-on. The numerical value is set for the “page ID” when printing is performed.

The “print side” is information for identifying whether an image to be printed is for single-sided printing, for printing on the front side of double-sided printing (doubled-sided front), or for printing on the back side of double-sided printing (double-sided back).

The “sheet ID” is identification information of a sheet. The “sheet ID” is incremented by 1 each time one sheet is processed since the power-on. The numerical value is set for the “sheet ID” when printing is performed. In the case of double-sided printing, the same sheet ID is set for job information for the front side and the back side of the sheet. However, the page ID is different between the front side and the back side of the sheet.

The “copy ID” is identification information in units of copies. The “copy ID” is incremented by 1 each time output of one copy is completed since the power-on. The numerical value is set for the “copy ID” when printing is performed.

The “job ID” is identification information in units of jobs. The “job ID” is incremented by 1 each time output of one job is completed since the power-on. The numerical value is set for the “job ID” when printing is performed.

The “sheet type” is information on the type of the sheet. The “sheet size” is information on the size of the sheet.

The “job type” is information for distinguishing between a job subjected to defect detection and a job not subjected to defect detection. Some types of sheets, for example, colored sheets are not supported by the inspection device 103 for inspection of a defect. A defect detection target indicates that the job is subjected to defect detection. A non-target indicates that the job is not subjected to defect detection.

The “initial value” is a value received by the system controller 201.

### Description of Inspection Device

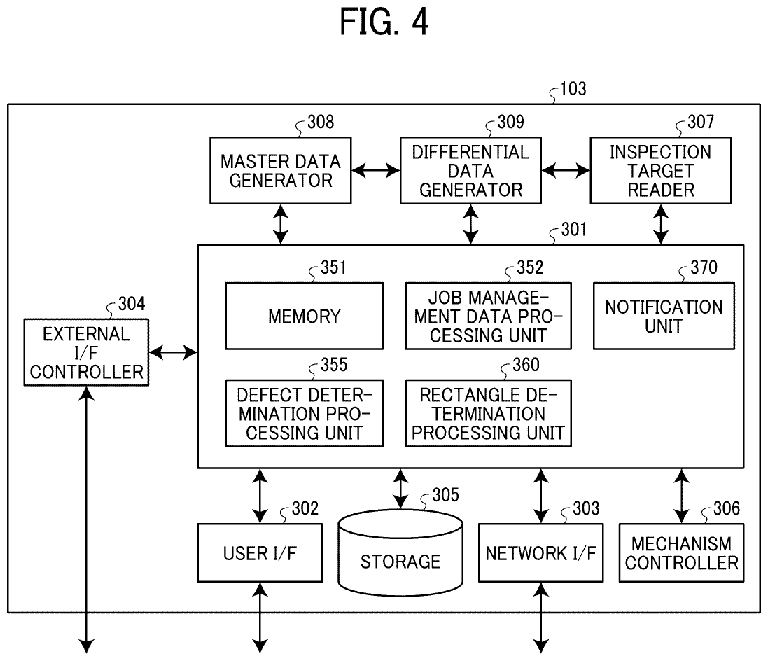

FIG. 4 is a diagram illustrating an example of a configuration of the inspection device 103. The inspection device 103 includes a system controller 301, a user I/F 302, a network I/F 303, an external I/F controller 304, a storage 305, a mechanism controller 306, an inspection target reader 307, a master data generator 308, and a differential data generator 309.

The system controller 301 is a controller that controls the entire inspection device 103.

The user I/F 302 is an interface that connects the system controller 301 to the operation device 133. The network I/F 303 is an interface that connects the system controller 301 to a network such as a LAN. The external I/F controller 304 is an interface for another device. The storage 305 is a storage device such as a hard disk drive. The mechanism controller 306 controls operations such as sheet conveyance in the inspection device 103.

The inspection target reader 307 reads the printed medium M, which is an inspection target, and outputs read image data as inspection target data. The master data generator 308 generates, from a RIP image, master data to be compared with the inspection target data. The RIP image is an example of print information corresponding to the printed medium M. The differential data generator 309 generates differential data between the master data and the inspection target data.

The system controller 301 includes a memory 351, a job management data processing unit 352, a defect determination processing unit 355, a rectangle determination processing unit 360, and a notification unit 370.

The system controller 301 receives job management information and RIP image data via the external I/F controller 304, and stores the job management information and the RIP image data in the memory 351. The job management data processing unit 352 extracts, from the job management data, information regarding processing to be performed by the stacker 104, which is a post-processing device, and transmits the extracted information to the stacker 104. The job management data processing unit 352 extracts printing management information from the job management information, and transfers the printing management information to the master data generator 308, the defect determination processing unit 355, the inspection target reader 307, and the mechanism controller 306. The printing management information is obtained by excluding the information regarding processing to be performed by the post-processing device from the job management information.

The system controller 301 stores the differential data in the memory 351, and notifies the defect determination processing unit 355 that determination is ready to be started.

The defect determination processing unit 355 performs defect determination on the differential data by using a defect determination threshold value set in advance. The defect determination threshold value can be set by the user using the operation device 133.

The rectangle determination processing unit 360 performs an inspection process according to the present embodiment to determine whether the inspection target is rectangular. Four vertices of the inspection target are detected from the inspection target data. Whether the inspection target is rectangular is determined based on whether angles of the four corners corresponding to the four vertices are close to 90°.

When the rectangle determination processing unit 360 determines that the inspection target is not rectangular, that is, a deformation is present in the inspection target, the notification unit 370 makes a notification indicating that a deformation is present in the inspection target. Specifically, the notification unit 370 displays, on the display unit of the operation device 133, a notification indicating that a deformation is present in the inspection target and information indicating a place of the deformation.

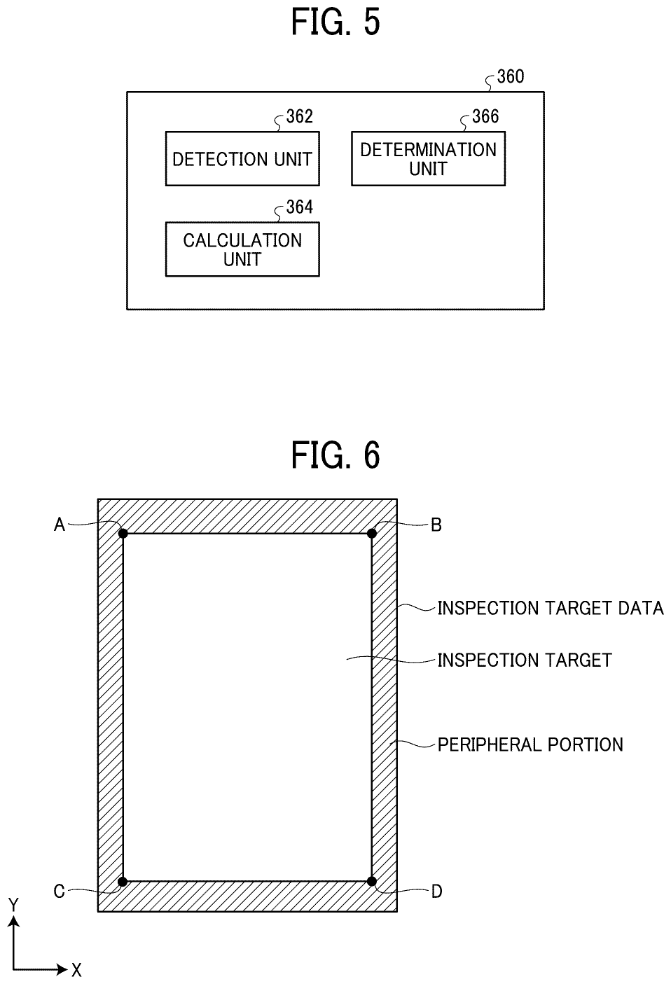

FIG. 5 is a block diagram illustrating a functional configuration of the inspection process of the inspection device 103 according to the present embodiment. As illustrated in FIG. 5, the rectangle determination processing unit 360 includes a detection unit 362, a calculation unit 364, and a determination unit 366.

The detection unit 362 detects vertices at four corners of the inspection target from the inspection target data. FIG. 6 is a diagram illustrating an example of vertices at four corners of the inspection target. As illustrated in FIG. 6, the inspection target data includes an area indicating the inspection target including four vertices A, B, C, and D and an area of a peripheral portion (area for a read background plate). The color of the peripheral portion is black. Among the coordinate axes, the X axis represents a main scanning direction and the Y axis represents a sub-scanning direction (a direction in which the medium is conveyed).

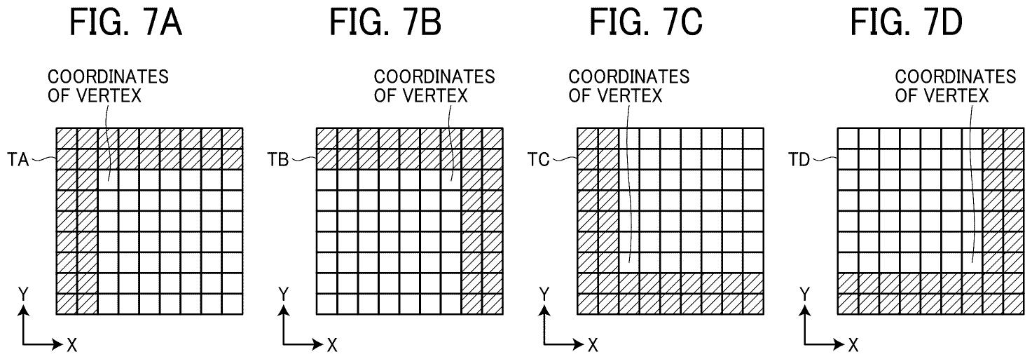

FIGS. 7A, 7B, 7C, and 7D are diagrams each illustrating an example of a template for detecting a vertex of the inspection target. In the present embodiment, a vertex is detected by template matching using a template. A template TA in FIG. 7A, a template TB in FIG. 7B, a template TC in FIG. 7C, and a template TD in FIG. 7D are templates for detecting the vertex A, the vertex B, the vertex C, and the vertex D, respectively. The templates TA, TB, TC, and TD are each made up of 9 pixels×9 pixels. Pixels in an obliquely hatched area have a pixel value of black corresponding to the peripheral portion. Pixels in the other area have a pixel value of white. “Coordinates of a vertex” in FIGS. 7A, 7B, 7C, and 7D correspond to coordinates of each of the vertices A to D detected by template matching.

For example, the detection unit 362 shifts the template TA to each position in a predetermined search range of the inspection target data and determines the sum of absolute values of differences between the template TA and the inspection target data. The detection unit 362 determines, as the coordinates of the vertex A, coordinates corresponding to the “coordinates of the vertex” of the template TA at a position where the sum of absolute values is the smallest. Likewise, the detection unit 362 determines the sums of absolute values of differences between the inspection target data and the templates TB to TD, and determines, as the coordinates of the vertices B to D, coordinates corresponding to the “coordinates of the vertex” of the templates TB to TD at positions where the respective sums of absolute values are the smallest. FIGS. 7A to 7D illustrate the templates of 9 pixels×9 pixels. However, the size of the templates is not limited to this size.

When the search range in which each template is shifted is set to the entire inspection target data, an amount of processing may increase and the sum of absolute values may be the smallest at a position other than the vertex of the inspection target data. Thus, the search range can be limited to a range near each vertex.

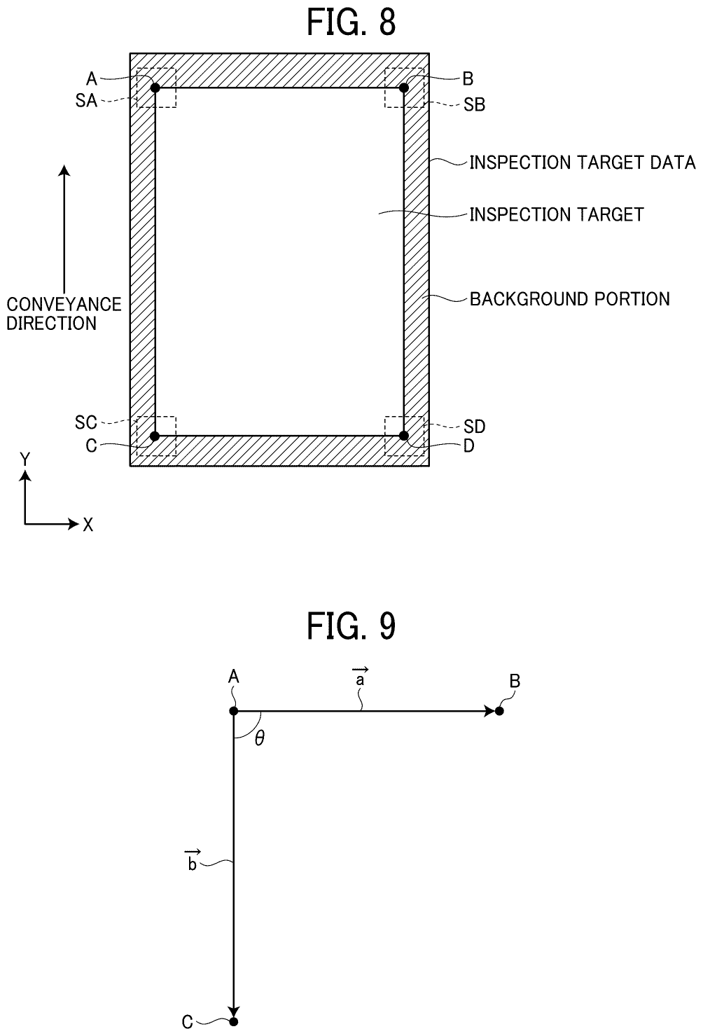

FIG. 8 is a diagram illustrating an example of the search range limited to an area near each vertex. In this example, ranges SA to SD, which are indicated by broken lines and near the respective vertices A to D, are search ranges in which the templates TA to TD are shifted, respectively. Note that each search range is a range determined in advance by experiments or the like.

Any one of the vertices A to D may be detected in a large search range, and the coordinates of the other vertices may be estimated from the detected vertex. In this way, the search ranges for the other vertices may be made small. For example, the vertex A is detected first. Then, the coordinates of the other vertices B to D are estimated using information on the sheet size and information on the skew of the sheet acquired by the inspection target reader 307. A peripheral area of the estimated coordinates may be set as the search range of the corresponding vertex. When the coordinates of the upper left point can be acquired by skew measurement of the sheet, a peripheral area of the acquired coordinates may be set as the search range for the vertex A.

When the skew-related shift increases upstream in the conveyance direction of the sheet, a relatively large search range (SC and SD in FIG. 8) may be set upstream in the conveyance direction.

The calculation unit 364 calculates angles of four corners of the inspection target. The angles of the four corners are four angles (∠CAB, ∠ABC, ∠DCA, and ∠BDC) corresponding to the respective vertices A to D. Each angle corresponding to a respective vertex can be calculated using an inner product of vectors.

FIG. 9 is a diagram illustrating an example of vectors for use in calculation of an angle. As illustrated in FIG. 9, let θ denote the angle ∠CAB corresponding to the vertex A. Then, θ is calculated using Equation (1). The coordinates of the vertex A and the coordinates of the vertex B are respectively defined as (Ax, Ay) and (Bx, By). The vectors in Equation (1) and components of the vectors are defined as Equations (2) and (3).

$$cos θ = \frac{\vec{a} \cdot \vec{b}}{\vert \vec{a} \vert \vert \vec{b} \vert} = \frac{{a}_{1} {b}_{1} + {a}_{2} {b}_{2}}{\sqrt{{{a}_{1}}^{2} + {{a}_{2}}^{2}} \sqrt{{{b}_{1}}^{2} + {{b}_{2}}^{2}}} \qquad ( 1 )$$

$$\vec{a} = ( {a}_{1} , {a}_{2} ) = ( Bx - Ax , By - Ay ) \qquad ( 2 )$$

$$\vec{b} = ( {b}_{1} , {b}_{2} ) = ( Cx - Ax , Cy - Ay ) \qquad ( 3 )$$

The calculation unit 364 calculates the other three angles (∠ABC, ∠DCA, and ∠BDC) in a similar manner.

The determination unit 366 determines whether a deformation is present in the inspection target. Specifically, when the angle calculated by the calculation unit 364 is outside a predetermined range, the determination unit 366 determines that a deformation is present in the inspection target. For example, when at least one of the four calculated angles is outside the predetermined range, the determination unit 366 determines that a deformation is present in the inspection target. The predetermined range is set as 90°±α (where α is a constant). When the calculated angle is outside the range of 90°±α, a deformation is determined to be present in the inspection target. For example, the predetermined range is a value set in advance at a manufacturing facility by experiments. As the predetermined range, a single range may be set for the four angles or different ranges may be set for different angles. A user may set or change the predetermined range via the operation device 133.

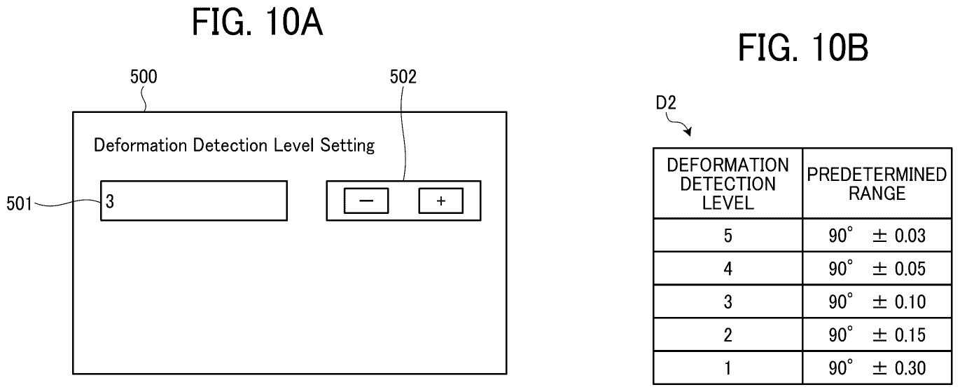

FIGS. 10A and 10B are diagrams illustrating an example of setting the predetermined range used by the determination unit 366. As illustrated in FIG. 10A, a deformation detection level setting screen 500 displayed on the display unit of the operation device 133 includes a deformation detection level area 501 and a setting change area 502. In this example, the deformation detection level is set to 3. The user can change the deformation detection level by operating the setting change area 502 via the operation device 133. The user can raise the deformation detection level by pressing a “+” button and lower the deformation detection level by pressing a “−” button in the setting change area 502.

For example, the predetermined range corresponding to the deformation detection level is defined as deformation detection level information D2 illustrated in FIG. 10B. In this example, the predetermined range narrows as the deformation detection level is raised and widens as the deformation detection level is lowered. The deformation detection level information D2 is stored in the storage 305. Note that different values of the deformation detection level may be set for four different angles. The user can change the deformation detection level information D2 via the operation device 133. The predetermined range may be an asymmetrical range with respect to 90° such as (90°−α1) to (90°+α2), where α1 and α2 are constants, instead of a symmetrical range with respect to 90°. Instead of setting the deformation detection level, the predetermined range may be set with numerical values of the range. For example, the numerical values of the predetermined range may be set to be “89.80° to 90.10°” by an operation on the operation device 133. Note that the deformation detection level setting screen 500 is an example of a range setting unit configured to set the predetermined range.

The predetermined range may be set using angles calculated by letting N sheets (where N is a natural number) of the inspection target pass through the inspection device 103. For example, before the printer 101 starts printing, N sheets of the inspection target are conveyed from the sheet feeder 105 to the inspection device 103. For each of the N sheets, angles at the four corners of the inspection target are calculated in the above-described manner. A statistical value of the calculated angles is determined for each vertex, and the predetermined range is set for each vertex. For example, for the angle ∠CAB corresponding to the vertex A, an average value EA and a standard deviation DA are determined to set the predetermined range to “EA±β×DA”. Alternatively, a maximum value MaxA and a minimum value MinA may be determined to set the predetermined range to “γ×MinA to δ×MaxA”. β, γ, and δ are values set in advance at a manufacturing facility by experiments.

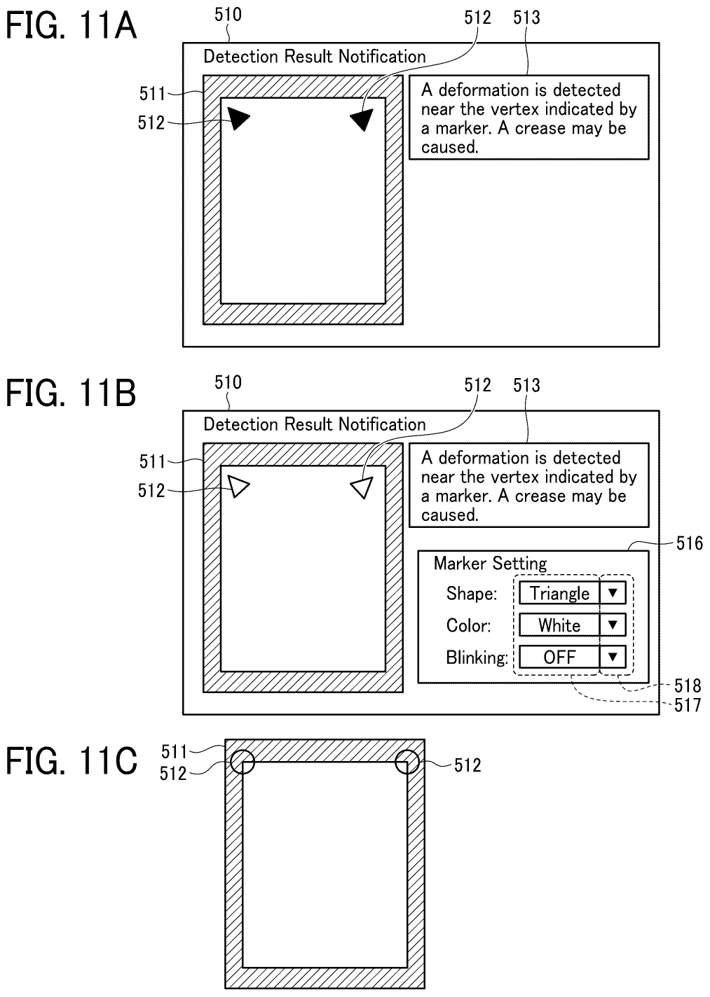

FIGS. 11A to 11C are diagrams each illustrating an example of a detection result notification displayed by the notification unit 370. As illustrated in FIG. 11A, a notification screen 510 includes an inspection target data area 511, markers 512, and a notification area 513. The inspection target data area 511 displays an image of the inspection target data.

The marker 512 is an example of information indicating a place of the deformation, and represents a vertex of which the corresponding angle is determined to be outside the predetermined range. The notification area 513 displays a notification indicating that a deformation of the inspection target is detected. In this example, a notification “A deformation is detected near the vertex indicated by a marker. A crease may be caused.” is displayed.

Note that the attribute of the shape of the marker 512 may be changed to be easily recognized visually by the user. For example, at least one of the shape (such as a triangle, circle, or arrow), the color (such as black, red, white, or magenta), or whether to blink (on/off of blinking of) the marker 512 may be set or changed via the operation device 133. FIG. 11B illustrates an example of the notification screen 510 to which a marker setting area 516 is added. As illustrated in FIG. 11B, the notification screen 510 further includes the marker setting area 516 in addition to the components of the screen illustrated in FIG. 11A. The marker setting area 516 includes an attribute value area 517 and a menu button 518. The attribute value area 517 displays setting values of the attributes such as the shape, the color, and the on/off of blinking of the marker 512. The menu button 518 is for setting or changing each attribute value by a pull-down menu. The marker setting area 516 is an example of a marker setting unit.

In FIG. 11B, the shape, the color, and blinking of the marker 512 are a triangle, white, and off, respectively. In this example, the color of the frame of the marker 512 is set to black. Thus, the “color” in the attribute value area 517 is for setting or changing the color for filling the marker 512. The marker 512 illustrated in FIG. 11C is an example in which the shape, the color, and blinking are set to a circle, white, and off, respectively. The attributes of the marker 512 displayed in the attribute value area 517 may include the color of the frame, the type of the frame (such as a solid line or a dotted line), and the filling type (a single color, an oblique line pattern, or no filling) of the marker 512 in addition to the color (filling color). For example, the attributes (such as the shape, the color of the frame, the type of the frame, the filling color, the filling type, and on/off of blinking) of the marker 512 are “triangle, black, solid line, black, single color, and OFF” in FIG. 11A and “circle, black, solid line, none, no filling, and OFF” in FIG. 11C, respectively. The marker setting area 516 is an example of a marker setting unit.

### Process Flow

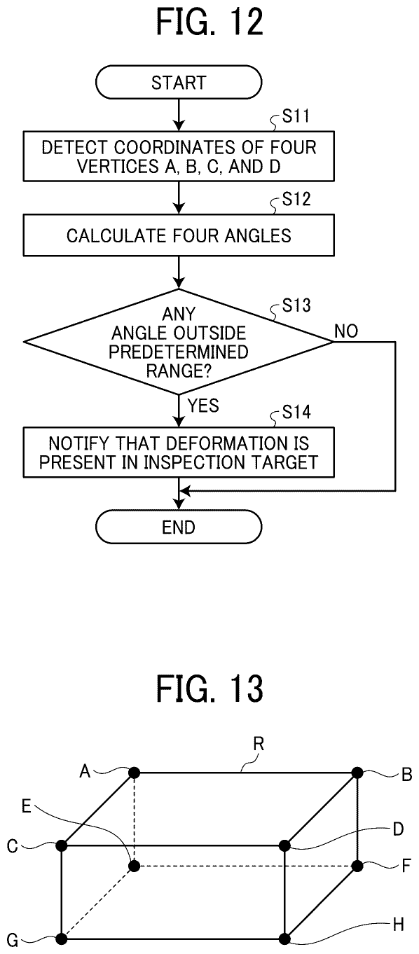

FIG. 12 is a flowchart illustrating an example of a procedure of the inspection process in the present embodiment. In step S11, the detection unit 362 detects coordinates of the four vertices A, B, C, and D.

In step S12, the calculation unit 364 calculates four angles corresponding to the four vertices A, B, C, and D.

In step S13, the determination unit 366 determines whether each of the angles is outside the predetermined range. When at least one angle is outside the predetermined range (step S13: Yes), the notification unit 370 outputs a notification indicating that a deformation is present in the inspection target in step S14. On the other hand, when each of the angles is within the predetermined range (step S13: No), the inspection target is determined to be deformation-free. The procedure of the inspection process then ends.

Since each of the front and back sides of the printed medium M is to be read by the inspection target reader 307, the inspection device 103 illustrated in FIG. 1 can use the inspection target data of the front side and the inspection target data of the back side to detect the deformation of the inspection target. The inspection target may be a 3D object, and faces to be read may be individual faces of the 3D object.

FIG. 13 is a diagram illustrating an example of the 3D object which is the inspection target. In this example, the 3D object is a rectangular parallelepiped R. The rectangular parallelepiped R has six faces and vertices A to H. In the present embodiment, to read each face of the rectangular parallelepiped R illustrated in FIG. 13, the inspection target reader 307 may have a configuration for reading each face from a direction of a normal to the face. In this case, the six read faces can be set as pieces of inspection target data, and a deformation of the inspection target can be detected using these pieces of inspection target data. For example, coordinates of the vertices A, B, C, and D are detected from the inspection target data of the upper face of the rectangular parallelepiped R, so that whether a deformation is present on the upper face is detectable. Coordinates of the vertices B, D, F, and H are detected from the inspection target data of the right face of the rectangular parallelepiped R, so that whether a deformation is present on the right face is detectable.

When a deformation is detected in the inspection target, the image forming apparatus 1 may perform a print operation similar to that of the case of detection of a defect in the related art (case where the defect determination processing unit 355 has detected a defect).

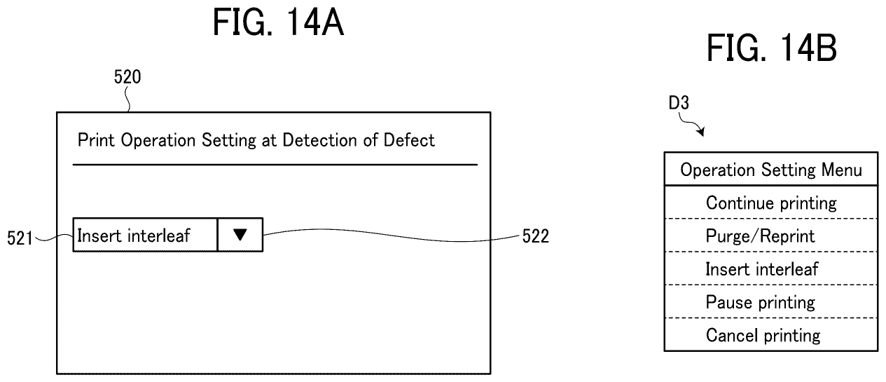

FIGS. 14A and 14B are diagrams illustrating an example of setting a print operation in the case of detection of a defect in the related art. As illustrated in FIG. 14A, a print operation setting screen 520 displayed on the display unit of the operation device 133 includes a defect detection operation area 521 and a menu button 522. The defect detection operation area 521 displays a name of the set operation. In this example, the operation to be performed at detection of a defect is set to “Insert interleaf”. The user can change the operation to be performed at detection of a defect by using the menu button 522.

FIG. 14B is a diagram illustrating an example of an operation setting menu for setting the operation to be performed at detection of a defect.

An operation setting menu D3 is a pull-down menu that is displayed when the user presses the menu button 522. The user selects the name of the operation from options of the operation setting menu D3 to set or change the operation to be performed at detection of a defect.

As described above, the setting of the print operation to be performed at detection of a defect is usable as the setting of the print operation to be performed at detection of a deformation in the inspection target. That is, when a deformation is detected in the inspection target, the image forming apparatus 1 can perform the operation set in FIG. 14A as in the case of detection of a defect in the related art (case where a vertical streak due to a scratch on a photoconductor is detected, for example).

As described above, vertices at four corners of a conveyed medium are detected. Angles formed for the vertices are calculated. Based on whether each of the angles is outside the predetermined range, whether a deformation is present in the medium is determined. Thus, with the present embodiment, whether a deformation caused in the medium is present can accurately detected.

### Second Embodiment

In a second embodiment, the number of times (determination count) a deformation is determined to be present in a medium is counted. When the determination count exceeds a predetermined value, a notification prompting improvement in a print operation or the like is made.

In the description of the second embodiment below, the description of a portion overlapping that of the first embodiment is omitted and differences from the first embodiment will be described.

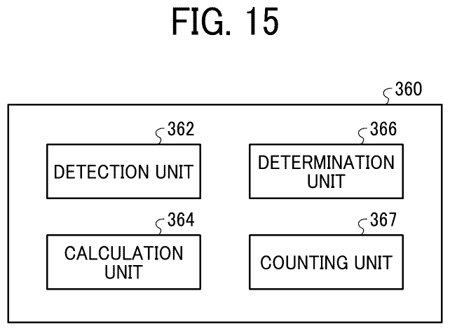

FIG. 15 is a block diagram illustrating a functional configuration of an inspection process of the inspection device 103 according to the present embodiment. Differences from the first embodiment are that the rectangle determination processing unit 360 includes a counting unit 367 and the notification unit 370 makes a notification prompting improvement. Since the other functional configuration and operation are substantially the same as those of the first embodiment, the description thereof is omitted.

The counting unit 367 counts the number of times (determination count) a deformation is determined to be present in a medium by the determination unit 366. For example, the counting unit 367 sets the determination count to 0 at the power-on of the image forming apparatus 1, and increments the determination count by 1 each time a deformation is determined to be present in a medium.

When the determination count exceeds a predetermined value HT, the notification unit 370 displays a notification prompting improvement on the display unit of the operation device 133. For example, the predetermined value HT is a value set in advance at a manufacturing facility by experiments. The predetermined value HT may be dynamically changed in accordance with the usage or the like of the image forming apparatus 1.

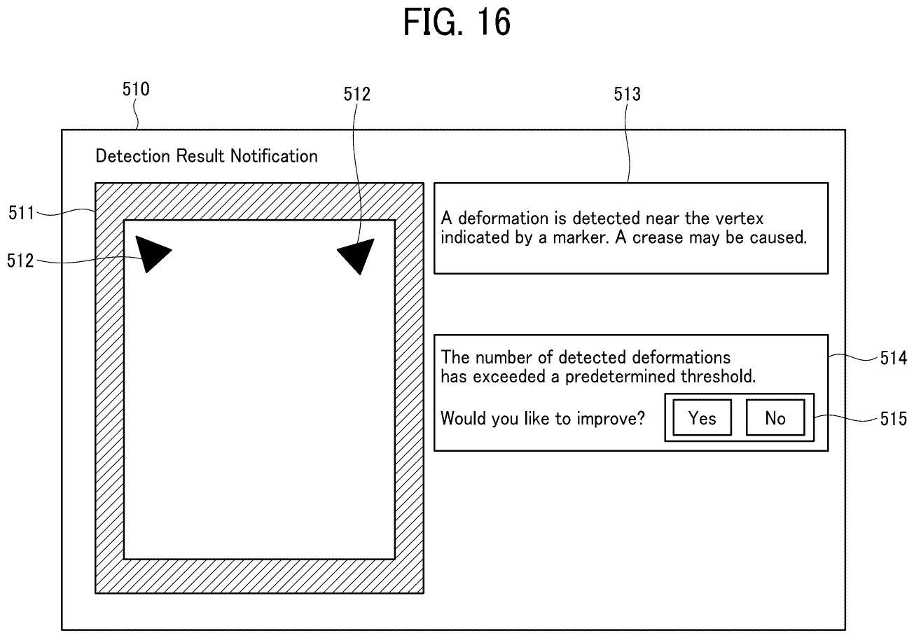

FIG. 16 is a diagram illustrating another example of the detection result notification displayed by the notification unit 370. A difference from the first embodiment is that the notification screen 510 includes an improvement notification area 514. Since the other areas are substantially the same as those of the first embodiment, the description thereof is omitted.

When the determination count exceeds the predetermined value HT, the notification unit 370 displays a notification prompting improvement as illustrated in FIG. 16 in the improvement notification area 514. In this example, a notification “The number of detected deformations has exceeded a predetermined threshold. Would you like to improve?” and a confirmation area 515 including “Yes” and “No” buttons are displayed. When the user presses the “Yes” button, a setting screen for improving the print operation is displayed. When the user presses the “No” button, the inspection process ends.

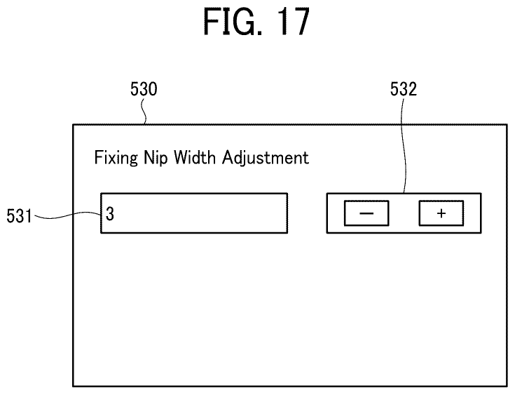

FIG. 17 is a diagram illustrating an example of a setting screen for improving the print operation. One of the causes for a deformation such as a crease is that the pressure applied by the fixing device 117 on a thin sheet is high.

Reducing the nip width (fixing nip width) of the fixing device 117 may help prevent the occurrence of a deformation and improve the print operation. Thus, an example of adjusting the fixing nip width will be described.

In FIG. 17, an improvement setting screen 530 includes a fixing nip width area 531 and a fixing nip width adjusting area 532. The fixing nip width area 531 presents a numerical value of the fixing nip width currently set. In this example, the fixing nip width is set to 3 mm. When the user presses a “−” button of the fixing nip width adjusting area 532 using the operation device 133, the fixing nip width is set to narrow. When the user presses a “+” button, the fixing nip width is set to widen. Note that the pressure applied by the fixing device 117 decreases as the fixing nip width narrows and increases as the fixing nip width widens.

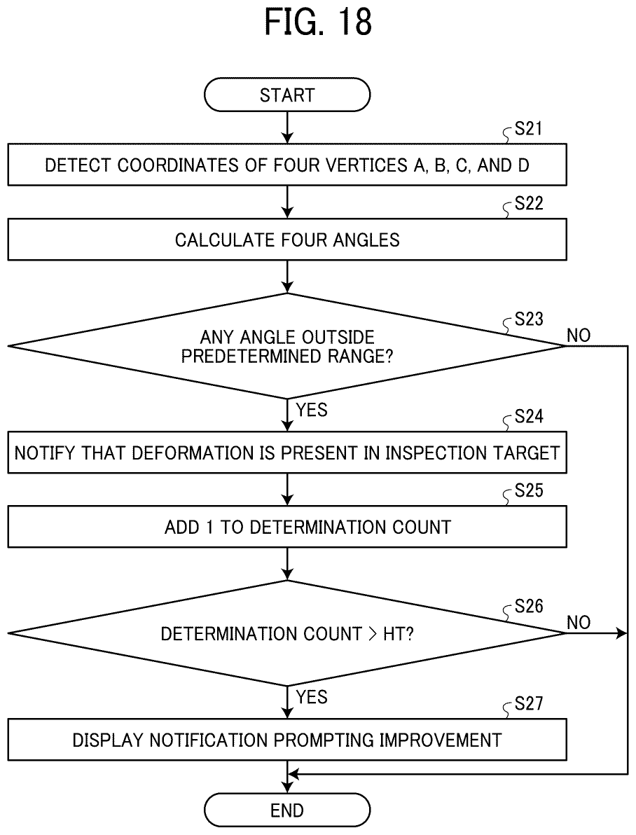

FIG. 18 is a flowchart illustrating an example of a procedure of the inspection process in the present embodiment. Differences from the first embodiment are that steps S25 to S27 are added. Since the procedure in steps S21 to S24 is substantially the same as that of the first embodiment, the description thereof is omitted.

When a notification indicating that a deformation is present in the inspection target is made (step S24), the counting unit 367 adds 1 to the determination count (step S25). When the determination count after the addition exceeds the predetermined value HT (step S26: Yes), the notification unit 370 displays a notification prompting improvement (step S27). On the other hand, when the determination count after the addition is less than or equal to the predetermined value HT (step S26: No), the procedure of the inspection process ends. Note that the inspection process is started each time the image forming apparatus 1 performs printing. The determination count is incremented by 1 each time a deformation is determined to be present in the inspection target.

As described above, when the number of times a deformation caused on a medium has been detected exceeds the predetermined threshold, a notification prompting improvement is made. Thus, the present embodiment enables the user to appropriately make improvement against a crease or the like.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

The program executed by the inspection device 103 in each embodiment has a module configuration including the above-described functional units (such as the detection unit 362, the calculation unit 364, the determination unit 366, the counting unit 367, and the notification unit 370). A central processing unit (CPU) that is actual hardware reads the program from the above-described storage medium and executes the program, so that the above-described functional units are loaded to a main storage device and the detection unit 362, the calculation unit 364, the determination unit 366, the counting unit 367, and the notification unit 370 are generated in the main storage device.

The program executed by the inspection device 103 in each embodiment is recorded on a computer-readable storage medium such as a compact disc read only memory (CD-ROM), a flexible disk (FD), a compact disc recordable (CD-R), or a digital versatile disc (DVD) in an installable or executable file format and is provided.

The program executed by the inspection device 103 in each embodiment may be stored in a computer connected to a network such as the Internet, and downloaded and thus provided through the network.

The aspects of the present disclosure are as follows, for example.

According to Aspect 1, an inspection device includes a reader, a detection unit, a calculation unit, and a determination unit. The reader reads data of an inspection target. The detection unit detects a vertex of the inspection target from the data of the inspection target read by the reader. The calculation unit calculates an angle indicating a shape of the inspection target at the vertex detected by the detection unit. The determination unit determines whether a deformation is present in the inspection target. The determination unit determines that a deformation is present in the inspection target when the angle calculated by the calculation unit is outside a predetermined range.

According to Aspect 2, in the inspection device of Aspect 1, the detection unit detects a plurality of vertices of the inspection target. The plurality of vertices include the vertex. The calculation unit calculates a plurality of angles including the angle and each corresponding to a respective vertex of the plurality of vertices. The determination unit determines that a deformation is present in the inspection target when at least one of the plurality of angles is outside the predetermined range.

According to Aspect 3, the inspection device of Aspect 1 or 2 further includes a notification unit. The notification unit makes a notification indicating that a deformation is present in the inspection target when the deformation is determined to be present in the inspection target.

According to Aspect 4, the inspection device of Aspect 2 further includes a notification unit. The notification unit makes a notification indicating that a deformation is present in the inspection target when the deformation is determined to be present in the inspection target. The notification unit makes the notification indicating that the deformation is present in the inspection target together with information indicating a place of the deformation.

According to Aspect 5, in the inspection device of Aspect 4, the information indicating the place of the deformation includes a marker. The inspection device further includes a marker setting unit. The marker setting unit sets at least one of a shape, a color, or blinking of the marker.

According to Aspect 6, the inspection device of any one of Aspects 1 to 5 further includes a range setting unit. The range setting unit sets the predetermined range.

According to Aspect 7, in the inspection device of any one of Aspects 1 to 5, the deformation of the inspection target includes a crease of the inspection target.

According to Aspect 8, the inspection device of any one of Aspects 3 to 5 further includes a counting unit. The counting unit counts a number of times a deformation is determined to be present in the inspection target. The notification unit makes a notification prompting improvement when the number of times exceeds a predetermined value.

According to Aspect 9, an image forming apparatus includes an image forming device, a fixing device, a reader, a detection unit, a calculation unit, a determination unit, and a memory. The image forming device forms an image on a medium that is conveyed. The fixing device fixes the image formed by the image forming device, onto the medium. The reader reads data of an inspection target that is the medium on which the image has been fixed by the fixing device. The detection unit detects a vertex of the inspection target from the data of the inspection target read by the reader. The calculation unit calculates an angle indicating a shape of the inspection target at the vertex detected by the detection unit. The determination unit determines whether a deformation is present in the inspection target. The memory stores a number of times a deformation is determined to be present in the inspection target. The determination unit determines that a deformation is present in the inspection target when the angle calculated by the calculation unit is outside a predetermined range.

According to Aspect 10, an inspection method to be executed by an inspection device, the inspection device including a reader to read data of an inspection target, includes: detecting a vertex of the inspection target from the data of the inspection target read by the reader; calculating an angle indicating a shape of the inspection target at the vertex detected in the detecting; and determining whether a deformation is present in the inspection target. In the determining, a deformation is determined to be present in the inspection target when the angle calculated in the calculating is outside a predetermined range.

According to Aspect 11, a program to be used in an inspection device, the inspection device including a reader to read data of an inspection target, causes a computer to function as detection means, calculation means, and determination means. The detection means detects a vertex of the inspection target from the data of the inspection target read by the reader. The calculation means calculates an angle indicating a shape of the inspection target at the vertex detected by the detection means. The determination means determines whether a deformation is present in the inspection target. The determination means determines that a deformation is present in the inspection target when the angle calculated by the calculation means is outside a predetermined range.

1. An inspection device comprising:
a reader to read data of an inspection target; and
circuitry configured to:
detect a vertex of the inspection target from the read data of the inspection target;
calculate an angle indicating a shape of the inspection target at the detected vertex; and
determine whether a deformation is present in the inspection target, wherein
the circuitry is configured to determine that a deformation is present in the inspection target when the calculated angle is outside a predetermined range.

2. The inspection device according to claim 1, wherein the circuitry is configured to:
detect a plurality of vertices of the inspection target, the plurality of vertices including the vertex;
calculate a plurality of angles including the angle and each corresponding to a respective vertex of the plurality of vertices; and
determine that a deformation is present in the inspection target when at least one of the plurality of angles is outside the predetermined range.

3. The inspection device according to claim 1, wherein the circuitry is configured to make a notification indicating that a deformation is present in the inspection target when the deformation is determined to be present in the inspection target.

4. The inspection device according to claim 2, wherein the circuitry is configured to make a notification indicating that a deformation is present in the inspection target together with information indicating a place of the deformation when the deformation is determined to be present in the inspection target.

5. The inspection device according to claim 4, wherein
the information indicating the place of the deformation includes a marker, and
the circuitry is configured to set at least one of a shape, a color, or blinking of the marker.

6. The inspection device according to claim 1, wherein the circuitry is configured to set the predetermined range.

7. The inspection device according to claim 1, wherein the deformation of the inspection target includes a crease of the inspection target.

8. The inspection device according to claim 3, wherein the circuitry is configured to:
count a number of times a deformation is determined to be present in the inspection target; and
make a notification prompting improvement when the number of times exceeds a predetermined value.

9. An image forming apparatus comprising:
an image forming device to form an image on a medium that is conveyed;
a fixing device to fix the formed image onto the medium;
a reader to read data of an inspection target that is the medium on which the image has been fixed;
circuitry configured to:
detect a vertex of the inspection target from the read data of the inspection target;
calculate an angle indicating a shape of the inspection target at the detected vertex; and
determine whether a deformation is present in the inspection target; and
a memory that stores a number of times a deformation is determined to be present in the inspection target, wherein
the circuitry is configured to determine that a deformation is present in the inspection target when the calculated angle is outside a predetermined range.

10. An inspection method performed by an inspection device, the inspection device including a reader to read data of an inspection target, the inspection method comprising:
detecting a vertex of the inspection target from the read data of the inspection target;
calculating an angle indicating a shape of the inspection target at the vertex detected in the detecting; and
determining whether a deformation is present in the inspection target, wherein
the determining includes determining that a deformation is present in the inspection target when the angle calculated in the calculating is outside a predetermined range.

11. A non-transitory recording medium storing a plurality of instructions which, when executed by one or more processors, causes the processors to perform the method according to claim 10.
